(19) United States
(12) Patent Application Publication
(10) Pub. No.: US 2026/0357830 A1
(43) Pub. Date: Nov. 12, 2026

(54) ANTI-SIPHONAGE AND ANTI-OVERFLOW OIL PUMP STRUCTUR

(71) Applicant: JUNMIN LE, Ningbo (CN)

(72) Inventor: JUNMIN LE, Ningbo (CN)

(21) Appl. No.: 19/218,945

(22) Filed: May 27, 2025

(30) Foreign Application Priority Data
May 6, 2025 (CN) 202510579029.8

(51) Int. Cl. F15D 1/14; F15D 1/02

(52) U.S. Cl. CPC F15D 1/14; F15D 1/02

(57) ABSTRACT

Disclosed is an anti-siphonage and anti-overflow oil pump structure. The anti-siphonage and anti-overflow oil pump structure includes an oil pump, an oil inlet pipe, a main flow channel assembly, a control box, an exhaust and backflow channel assembly, and an oil outlet pipe, where the control box includes a housing, a battery assembly, and a control board; the main flow channel assembly includes an input channel, an output channel, an exhaust port, and a seal port; and the exhaust and backflow channel assembly includes an exhaust valve, a pipeline joint, an exhaust pipe, and an exhaust and backflow channel, the exhaust valve is arranged inside the exhaust port, the pipeline joint is arranged above the exhaust valve, one end of the exhaust pipe is connected to the pipeline joint, and the other end of the exhaust pipe is connected to the exhaust and backflow channel.

### CROSS-REFERENCE TO RELATED APPLICATIONS

This application claims priority to Chinese Patent Application No. 202510579029.8, filed on May 6, 2025, which is hereby incorporated by reference in its entirety.

### TECHNICAL FIELD

The present disclosure relates to the technical field of oil pumps, and particularly relates to an anti-siphonage and anti-overflow oil pump structure.

### BACKGROUND

An oil pump is mainly used for pumping gasoline or diesel from an oil drum to a vehicle, a ship, or a mechanical oil-fired apparatus for its operation. The oil pump can also pump fuel oil from an oil tank of the mechanical apparatus, so an operator can conveniently maintain and overhaul the mechanical apparatus. A portable oil pump is applied to various scenarios in a broad range.

A flow channel structure of an existing portable oil pump on the current market is generally integrated with a pump housing. The structure of parts is complex, leading to complex production and assembly processes and inconvenient operation. Moreover, a ventilation valve is arranged at the flow channel of the existing portable oil pump. The structure is complex and requirements for precision of the parts are high, so oil leakage and siphonage will occur.

An exhaust structure of the existing oil pump is equipped with a one-way exhaust valve which risks seal failure. An exhaust channel is in communication with a liquid pressure flow channel. Once the exhaust valve fails, liquid will directly enter a controller through the exhaust channel and even flows to the external environment, and pollute and damage internal control components and the environment, causing control failure and environmental pollution. Accordingly, the product cannot work anymore. In addition, when an oil outlet is lower than an oil surface, even if the oil pump stops working, oil will still flow out through the oil outlet under the action of gravity.

### SUMMARY

The present disclosure provides an anti-siphonage and anti-overflow oil pump structure. A double-channel coupling design structure is used, and an exhaust outlet is led to an outlet of an oil drum such that leaked oil can flow back into the oil drum.

In order to achieve the above objective, the present disclosure provides an anti-siphonage and anti-overflow oil pump structure. The anti-siphonage and anti-overflow oil pump structure includes an oil pump, an oil inlet pipe, a main flow channel assembly, a control box, an exhaust and backflow channel assembly, and an oil outlet pipe. The control box includes a housing, a battery assembly, and a control board. The main flow channel assembly is arranged below the housing and is in communication with an interior of the housing. The main flow channel assembly includes an input channel, an output channel, an exhaust port, and a seal port. One end of the oil inlet pipe is connected to the oil pump through a first connection kit, and the other end of the oil inlet pipe is connected to the input channel through a second connection kit. The oil outlet pipe is connected to the output channel through a third connection kit. The exhaust and backflow channel assembly is arranged inside the housing and located below the control board. The exhaust and backflow channel assembly includes an exhaust valve, a pipeline joint, an exhaust pipe, and an exhaust and backflow channel. The exhaust valve is arranged inside the exhaust port. The pipeline joint is arranged above the exhaust valve. One end of the exhaust pipe is connected to the pipeline joint, and the other end of the exhaust pipe is connected to the exhaust and backflow channel. The exhaust and backflow channel is fixedly arranged at a bottom end of the housing.

Further, the battery assembly includes a battery cover, a battery, and an upper housing. The upper housing covers an upper portion of the interior of the housing. The battery is arranged inside the upper housing. The battery cover covers an upper portion of the battery to form a battery accommodating bin together with the upper housing.

Further, the control board is arranged inside another side of the upper housing and electrically connected to the battery.

Further, one end of the exhaust and backflow channel is located inside the bottom end of the housing and connected to the exhaust pipe, and the other end of the exhaust and backflow channel is located outside the bottom end of the housing and connected to an opening of an oil drum.

Further, a seal plug sleeve is arranged inside the seal port, and the seal plug sleeve is arranged inside the housing.

Further, each of the first connection kit, the second connection kit, and the third connection kit is composed of a connection sleeve, a sleeve pipe, and a seal ring.

Further, a nut connector is arranged at an exterior of the second connection kit in a sleeve manner and used for being fixedly connected to a drum opening of an oil drum.

Further, the exhaust valve is a one-way soft rubber exhaust valve.

An anti-siphonage and anti-overflow oil pump structure provided in the present disclosure has the beneficial effects as follows:

According to the present disclosure, a double-channel coupling design structure is used, a dynamic pressure balance cavity is formed inside a main flow channel, and an exhaust outlet is led to an outlet of an oil drum. In an oil pumping process, leaked oil can flow back into the oil drum through dynamic compensation, such that oil leakage and siphonage of the oil pump are effectively relieved.

### BRIEF DESCRIPTION OF DRAWINGS

Accompanying drawings serve as a constituent part of the present disclosure to provide a further understanding of the present disclosure, such that other features, objectives, and advantages of the present disclosure become clearer. The accompanying drawings of illustrative examples of the present disclosure and their descriptions are used for explaining the present disclosure, but are not intended to unduly limit the present disclosure. In the accompanying drawings,

FIG. 1 is a schematic diagram of an anti-siphonage and anti-overflow oil pump structure according to an example of the present disclosure;

FIG. 2 is an exploded view of an interior of an anti-siphonage and anti-overflow oil pump structure according to an example of the present disclosure;

FIG. 3 is a sectional view of a main flow channel of an anti-siphonage and anti-overflow oil pump structure according to an example of the present disclosure; and

FIG. 4 is a sectional view of an exhaust and backflow channel of an anti-siphonage and anti-overflow oil pump structure according to an example of the present disclosure.

In the figures: 1—oil inlet pipe, 2—main flow channel assembly, 21—input channel, 22—output channel, 23—exhaust port, 24—seal port, 241—seal plug sleeve, 3—control box, 31—housing, 32—battery assembly, 321—battery cover, 322—battery, 323—upper housing, 33—control board, 4—exhaust and backflow channel assembly, 41—exhaust valve, 42—pipeline joint, 43—exhaust pipe, 44—exhaust and backflow channel, 5—oil outlet pipe, 6—connection sleeve, 7—sleeve pipe, 8—seal ring, 9—nut connector, and 10—oil pump.

### DESCRIPTION OF EMBODIMENTS

In order to enable a person skilled in the art to better understand the solutions of the present disclosure, the technical solutions of examples of the present disclosure will be described clearly and comprehensively below in combination with accompanying drawings of the examples of the present disclosure. Clearly, the examples described are merely some examples of the present disclosure, rather than all examples of the present disclosure. Based on the examples of the present disclosure, all other examples derived by a person of ordinary skill in the art without making creative efforts should fall within the scope of protection of the present disclosure.

It should be noted that the terms “first”, “second”, etc. in the description and claims of the present disclosure and in the above accompanying drawings are used for distinguishing between similar objects and not certainly used for describing particular order or sequential order. It should be understood that data used in this way can be interchanged where appropriate such that examples of the present disclosure can be conveniently described herein. In addition, the terms “comprise”, “include”, “have” and their variations are intended to cover non-exclusive inclusion. For instance, a process, method, system, product, or apparatus, which includes a series of steps or units, is not required to be limited by those explicitly listed, but can include other steps or units not explicitly listed or inherent to the process, method, product, or apparatus.

In the present disclosure, the terms “upper”, “lower”, “left”, “right”, “front”, “rear”, “top”, “bottom”, “internal”, “external”, “middle”, “vertical”, “horizontal”, “transverse”, “longitudinal”, etc. indicate orientational or positional relationships based on those shown in the accompanying drawings. These terms are mainly used for better describing the present disclosure and the examples, and are not used for limiting that the indicated device, element, or component must have a particular orientation or be constructed and operated in a particular orientation.

Moreover, some of the above terms may be used for indicating other meanings besides orientational or positional relationships. For instance, the term “upper” may be used for indicating a dependence or connection relationship in some cases. A person of ordinary skill in the art can understand the specific meanings of these terms in the present disclosure according to specific cases.

In addition, the term “plurality of” shall mean two or more.

It should be noted that examples in the present disclosure and features in the examples may be combined with one another without conflicts. The present disclosure will be described in detail below with reference to accompanying drawings and in combination with examples.

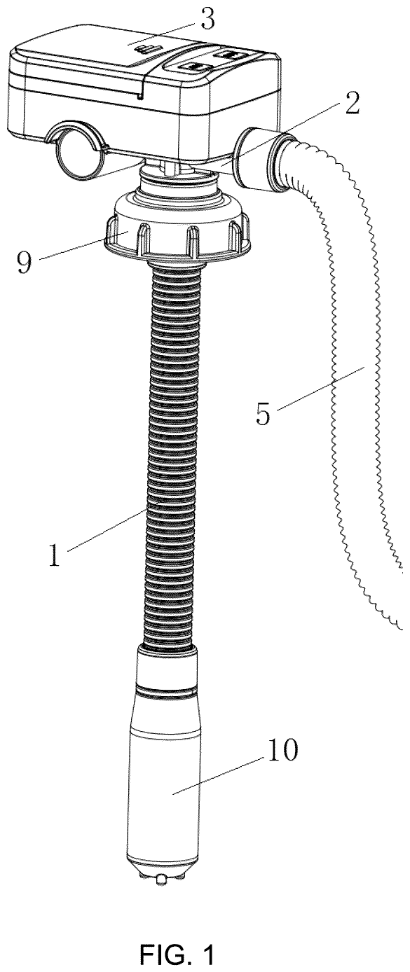

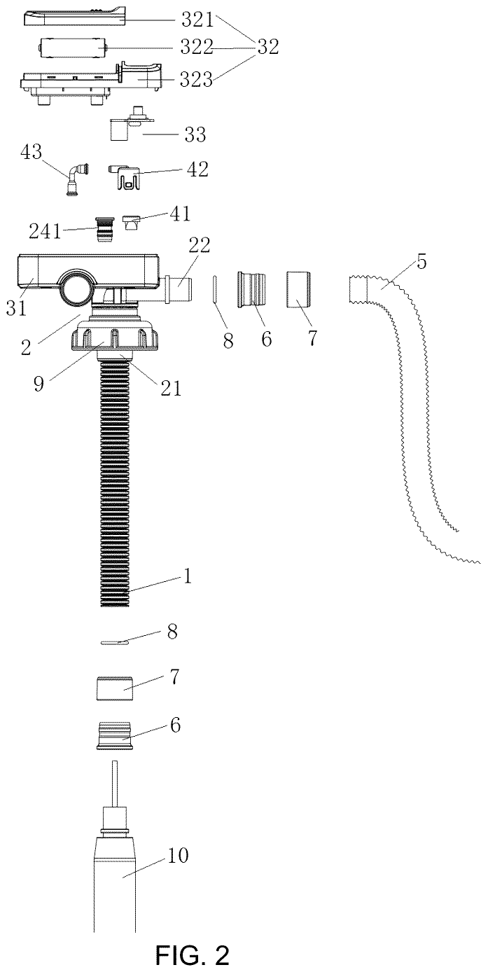

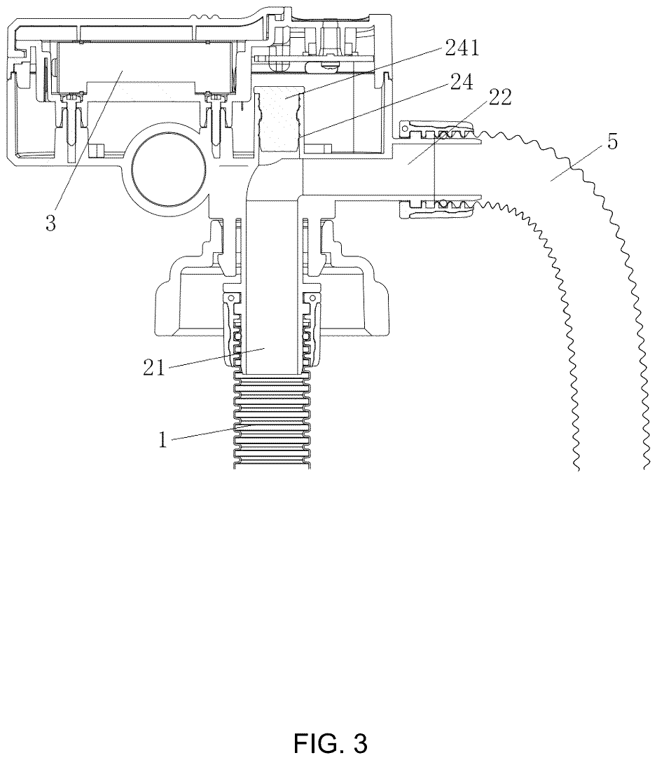

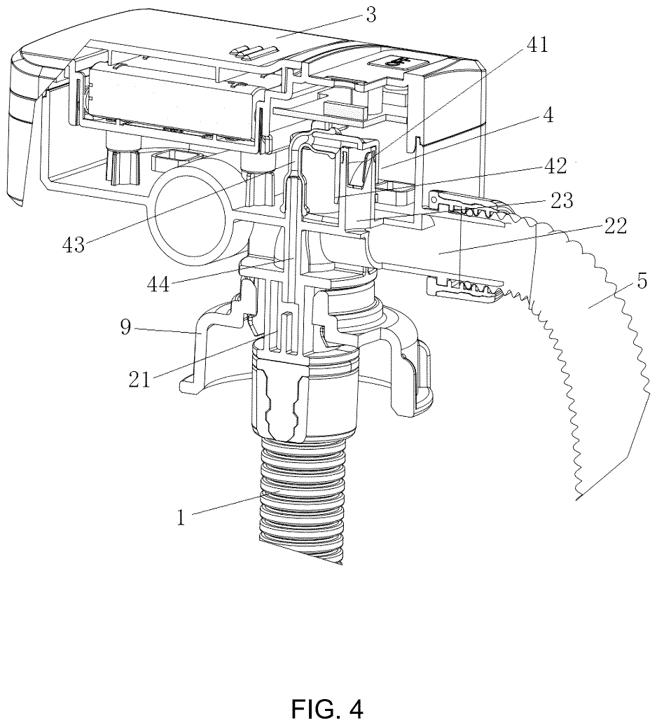

As shown in FIG. 1-FIG. 4, the present disclosure provides an anti-siphonage and anti-overflow oil pump structure. The anti-siphonage and anti-overflow oil pump structure includes an oil pump 10, an oil inlet pipe 1, a main flow channel assembly 2, a control box 3, an exhaust and backflow channel assembly 4, and an oil outlet pipe 5. The control box 3 includes a housing 31, a battery assembly 32, and a control plate 33. The main flow channel assembly 2 is arranged below the housing 31 and is in communication with an interior of the housing 31. The main flow channel assembly 2 includes an input channel 21, an output channel 22, an exhaust port 23, and a seal port 24. One end of the oil inlet pipe 1 is connected to the oil pump 10 through a first connection kit, and the other end of the oil inlet pipe is connected to the input channel 21 through a second connection kit. The oil outlet pipe 5 is connected to the output channel 22 through a third connection kit. The exhaust and backflow channel assembly 4 is arranged inside the housing 31 and located below the control board 33. The exhaust and backflow channel assembly 4 includes an exhaust valve 41, a pipeline joint 42, an exhaust pipe 43, and an exhaust and backflow channel 44. The exhaust valve 41 is arranged inside the exhaust port 23. The pipeline joint 42 is arranged above the exhaust valve 41. One end of the exhaust pipe 43 is connected to the pipeline joint 42, and the other end of the exhaust pipe is connected to the exhaust and backflow channel 44. The exhaust and backflow channel 44 is fixedly arranged at a bottom end of the housing 31.

Specifically, the anti-siphonage and anti-overflow oil pump structure provided in an example of the present disclosure is mainly used for pumping gasoline or diesel oil from an interior of an oil drum or an oil tank. The oil pump 10 and the oil inlet pipe 1 are inserted into the oil drum, the oil inlet pipe 1 is connected to the oil pump 10 through the first connection kit, and the oil pump 10 is located below an oil surface inside the oil drum. The main flow channel assembly 2 is equivalent to a three-way structure assembly and integrally embedded in the housing 31 below the control box 3. The input channel 21 is arranged below the housing 31 and connected to the oil inlet pipe 1 through the second connection kit. The output channel 22 is arranged on a side of the housing 31 and connected to the oil outlet pipe 5 through the third connection kit. The exhaust port 23 and the seal port 24 extend to the interior of the housing 31. The exhaust port 23 is used for being in butt-joint with the exhaust and backflow channel assembly 4 to discharge gas and enable oil to flow back. The seal port 24 is used for adjusting pressure inside the channel and radiating heat. The exhaust and backflow channel assembly 4 includes the exhaust valve 41, the pipeline joint 42, the exhaust pipe 43, and the exhaust and backflow channel 44. The exhaust valve 41 is arranged inside the exhaust port 23. The pipeline joint 42 is arranged above the exhaust valve 41. One end of the exhaust pipe 43 is connected to the pipeline joint 42, and the other end of the exhaust pipe is connected to the exhaust and backflow channel 44. The exhaust and backflow channel 44 is fixedly arranged at a bottom end of the housing 31. The control box 3 plays a role of power supply and control. During oil pumping, the oil pump 10 is started through the control box 3. Oil in the oil drum flows in the main flow channel assembly 2, that is, enters the input channel 21 along the oil inlet pipe 1, and then flows out through the output channel 22 and the oil outlet pipe 5. The oil outlet pipe 5 is subsequently connected to an oil outlet device such as an oil gun such that oil pumping can be implemented. In the oil pumping process, if seal of the exhaust valve 41 fails, or other phenomena that oil is left and leaked occur, the oil left and leaked will enter the exhaust and backflow channel 44 through the exhaust valve 41 and the exhaust pipe 43 and then flow back into the oil drum along the exhaust and backflow channel 44, will not be directly leaked into the control box 3, and thus will not affect a control system and other structures of the oil pump.

Further, the battery assembly 32 includes a battery cover 321, a battery 322, and an upper housing 323. The upper housing 323 covers an upper portion of the interior of the housing 31. The battery 322 is arranged inside the upper housing 323. The battery cover 321 covers an upper portion of the battery 322 to form a battery accommodating bin together with the upper housing 323. The battery assembly 32 is arranged at an upper half portion of the control box 3, and mainly used for accommodating the battery 322 and supplying power to various external structures. A battery accommodating bin is formed above the housing 31 and used for accommodating the battery 322. A charging structure may be arranged according to actual situations and is used for charging the battery 322.

Further, the control board 33 is arranged inside another side of the upper housing 323 and electrically connected to the battery 322. The control board 33 is arranged on one side of the battery 322 accommodating bin. A control button is arranged on the control board and used for turning on or off the oil pump 10 to control a working state of the oil pump 10.

Further, one end of the exhaust and backflow channel 44 is located inside the bottom end of the housing 31 and connected to the exhaust pipe 43, and the other end of the exhaust and backflow channel is located outside the bottom end of the housing 31 and connected to an opening of the oil drum. The exhaust and backflow channel 44 is mainly used for being connected to the oil drum such that the leaked oil can flow back into the oil drum. The exhaust and backflow channel 44 is integrally fixed to the bottom end of the housing 31. According to actual situations, the exhaust and backflow channel and the housing 31 may be integrally formed, and a lower end of the exhaust and backflow channel is directly connected to the opening of the oil drum. Or a hole may be provided at the bottom end of the housing 31, an upper end of the exhaust and backflow channel 44 is inserted into the housing 31 and fixed, and a lower end of the exhaust and backflow channel extends to an exterior of the housing 31 and is connected to the opening of the oil drum. When the exhaust valve 41 fails or oil in the main flow channel is leaked, the leaked oil will enter the exhaust and backflow channel 44 through the exhaust valve 41, the pipeline joint 42, and the exhaust pipe 43 in sequence, and flow back into the oil drum through the exhaust and backflow channel 44. Thus, the leaked oil can be prevented from affecting operation of the control system.

Further, a seal plug sleeve 241 is arranged inside the seal port 24, and the seal plug sleeve 241 is arranged inside the housing 31. The seal plug sleeve 241 is mainly used for adjusting airflow at the seal port 24 to maintain balance of pressure inside and outside the main flow channel and prevent breakdown or failure of the seal assembly caused by a pressure difference. Moreover, the seal plug sleeve can dissipate heat to prevent breakdown of the apparatus caused by flowing and overheating of the oil.

Further, each of the first connection kit, the second connection kit, and the third connection kit is composed of a connection sleeve 6, a sleeve pipe 7, and a seal ring 8. The first connection kit and the second connection kit are used for connections of two ends of the oil inlet pipe 1. The third connection kit is used for a connection of the oil outlet pipe 5. A connection structure including a connection sleeve 6, a sleeve pipe 7 and a seal ring 8 is used for the connection kit, such that a connection between the oil inlet pipe 1/the oil outlet pipe 5 and the channel is more stable, and oil leakage is prevented.

Further, a nut connector 9 is arranged at an exterior of the second connection kit in a sleeve manner and used for being fixedly connected to an opening of an oil drum. The nut connector 9 is arranged at a joint among the input channel 21, the exhaust and backflow channel 44, and the opening of the oil drum. The nut connector 9 is used for being in butt-joint with the oil drum. Threads are arranged at the opening of the oil drum. The input channel 21 and the exhaust and backflow channel 44 are integrally screwed and fixed to the opening of the oil drum through the nut connector 9. In this way, the oil inlet pipe 1 and the oil pump 10 can be stably inserted into the oil drum, and leaked oil from the exhaust and backflow channel 44 in the input channel 21 can flow back to the oil drum. Thus, stability and reliability of the oil pumping process can be ensured.

Further, the exhaust valve 41 is a one-way soft rubber exhaust valve. When the oil pump 10 stops working, the oil in the main flow channel will generate negative pressure due to gravity. At this time, atmospheric pressure outside the exhaust valve 41 will be greater than negative pressure inside the exhaust valve, and the exhaust valve 41 will be turned on to allow gas to enter the flow channel such that siphonage of the flow channel can be avoided. When the oil pump 10 starts working, due to the pressure in the main flow channel, liquid pressure inside the exhaust valve 41 will be greater than atmospheric pressure outside the exhaust valve, such that the exhaust valve 41 will be turned off, and oil can be prevented from being leaked to the outside. Even if the exhaust valve 41 fails and oil is leaked, the leaked oil will flow back to the oil drum through the exhaust valve 41, the exhaust pipe 43, and the exhaust and backflow channel 44 without affecting the entire oil pump 10. The exhaust valve 41 is preferably a one-way soft rubber valve normally turned off, and can be turned on only when pressure in the flow channel is lower than external atmospheric pressure. Thus, the exhaust valve has excellent pressure resistance and long service life, and is less prone to corrosion failure. By arranging the exhaust and backflow channel assembly 4, leaked oil or left oil can flow back into the oil drum, and siphonage of the oil pump and oil leakage are resolved.

The above examples are merely preferred examples of the present disclosure, and are not used for limiting the present disclosure. A person skilled in the art can make various modifications and changes on the present disclosure. Any modifications, equivalent substitutions, improvements, etc. within the spirit and principles of the present disclosure should fall within the scope of protection of the present disclosure.

What is claimed is:

1. An anti-siphonage and anti-overflow oil pump structure, comprising an oil pump, an oil inlet pipe, a main flow channel assembly, a control box, an exhaust and backflow channel assembly, and an oil outlet pipe, wherein
the control box comprises a housing, a battery assembly, and a control board;
the main flow channel assembly is arranged below the housing and is in communication with an interior of the housing;
the main flow channel assembly comprises an input channel, an output channel, an exhaust port, and a seal port;
one end of the oil inlet pipe is connected to the oil pump through a first connection kit, and the other end of the oil inlet pipe is connected to the input channel through a second connection kit;
the oil outlet pipe is connected to the output channel through a third connection kit;
the exhaust and backflow channel assembly is arranged inside the housing and located below the control board; and
the exhaust and backflow channel assembly comprises an exhaust valve, a pipeline joint, an exhaust pipe, and an exhaust and backflow channel, the exhaust valve is arranged inside the exhaust port, the pipeline joint is arranged above the exhaust valve, one end of the exhaust pipe is connected to the pipeline joint, the other end of the exhaust pipe is connected to the exhaust and backflow channel, and the exhaust and backflow channel is fixedly arranged at a bottom end of the housing.

2. The anti-siphonage and anti-overflow oil pump structure according to claim 1, wherein the battery assembly comprises a battery cover, a battery, and an upper housing,
the upper housing covers an upper portion of the interior of the housing;
the battery is arranged inside the upper housing; and
the battery cover covers an upper portion of the battery to form a battery accommodating bin together with the upper housing.

3. The anti-siphonage and anti-overflow oil pump structure according to claim 2, wherein the control board is arranged inside another side of the upper housing and electrically connected to the battery.

4. The anti-siphonage and anti-overflow oil pump structure according to claim 3, wherein one end of the exhaust and backflow channel is located inside the bottom end of the housing and connected to the exhaust pipe, and the other end of the exhaust and backflow channel is located outside the bottom end of the housing and connected to an opening of an oil drum.

5. The anti-siphonage and anti-overflow oil pump structure according to claim 4, wherein a seal plug sleeve is arranged inside the seal port, and the seal plug sleeve is arranged inside the housing.

6. The anti-siphonage and anti-overflow oil pump structure according to claim 5, wherein each of the first connection kit, the second connection kit, and the third connection kit is composed of a connection sleeve, a sleeve pipe, and a seal ring.

7. The anti-siphonage and anti-overflow oil pump structure according to claim 6, wherein a nut connector is arranged at an exterior of the second connection kit in a sleeve manner and used for being fixedly connected to an opening of an oil drum.

8. The anti-siphonage and anti-overflow oil pump structure according to claim 7, wherein the exhaust valve is a one-way soft rubber exhaust valve.
